(19) United States
(12) Patent Application Publication
(10) Pub. No.: US 2021/0151206 A1
(43) Pub. Date: May 20, 2021

(54) Apparatus And Method For Sourcing Fusion Reaction Products

(71) Applicants: The Regents of the University of California, Oakland, CA (US); Google Inc., Mountain View, CA (US); The University of British Columbia, Vancouver (CA)

(72) Inventors: Thomas Schenkel, San Francisco, CA (US); Ross Koningstein, Atherton, CA (US); Peter Seidl, Oakland, CA (US); Arun Persaud, El Cerrito, CA (US); Qing Ji, Albany, CA (US); David K. Fork, Mountain View, CA (US); Matthew D. Trevithick, Portola Valley, CA (US); Curtis Berlinguette, Vancouver (CA); Philip A. Schauer, Vancouver (CA); Benjamin P. MacLeod, Vancouver (CA)

(21) Appl. No.: 16/806,760

(22) Filed: Mar. 2, 2020

Related U.S. Application Data
(60) Provisional application No. 62/937,716, filed on Nov. 19, 2019.

(51) Int. Cl. G21B 1/17; G21B 1/11; G21B 1/19

(52) U.S. Cl. CPC G21B 1/17; G21B 1/19; G21B 1/115

(57) ABSTRACT

An apparatus and method for sourcing nuclear fusion products uses an electrochemical loading process to load low-kinetic-energy (low-k) light element particles into a target electrode, which comprises a light-element-absorbing material (e.g., Palladium). An electrolyte solution containing the low-k light element particles is maintained in contact with a backside surface of the target electrode while a bias voltage is applied between the target electrode and an electrochemical anode, thereby causing low-k light element particles to diffuse from the backside surface to an opposing frontside surface of the target electrode. High-kinetic-energy (high-k) light element particles are directed against the frontside, thereby causing fusion reactions each time a high-k light element particle operably collides with a low-k light element particle disposed on the frontside surface. Fusion reaction rates are controlled by adjusting the bias voltage.

### RELATED APPLICATIONS

This application claims priority from U.S. Provisional patent application 62/937,716, entitled “APPARATUS AND METHOD FOR SOURCING FUSION REACTION PRODUCTS”, which was filed on Nov. 19, 2019, and is incorporated by reference herein.

### STATEMENT OF GOVERNMENT SUPPORT

This invention was made with government support under Contract No. DE-AC02-05CH11231 awarded by the U.S. Department of Energy. The government has certain rights in this invention.

### FIELD OF THE INVENTION

This invention relates to nuclear reactions, and more particularly to apparatus/methods for sourcing neutrons and other fusion reaction products.

### BACKGROUND OF THE INVENTION

Small-scale neutron generators are used by universities and laboratories to conduct various forms of research in several branches of science (e.g., physics, chemistry, biology, engineering and medicine), and more recently in the study of hydrogen fusion reactions as part of the quest for utilizing nuclear fusion as an energy source and in nuclear astrophysics, particularly the effects of electron screening on fusion yields. As used herein, the phrase “neutron source” broadly refers to any device that emits neutrons, irrespective of the fission-based or fusion-based mechanism utilized to generate the neutrons, whereas the phrase “neutron generator” refers to a class of neutron source devices that utilize fusion-based mechanisms, and more particularly to devices that involve the fusion of at least one hydrogen isotope (e.g., the fusion of one deuterium or one tritium nucleus and a deuterium nucleus, or the fusion of a proton (¹H) and a boron nucleus). The small-scale neutron generators typically used for research purposes produce neutrons (and other fusion reaction products) by colliding together hydrogen isotope atoms (i.e., deuterium and/or tritium). As described below with reference to FIG. 13, a vacuum chamber and other bulky equipment are required to facilitate this fusion-based mechanism. In contrast, small-scale fission-based neutron sources typically generate neutrons using radioactive source materials (e.g., the spontaneous decay of unstable isotopes such as californium-252), thereby avoiding the bulky equipment needed by small-scale neutron generators. However, the storage and maintenance of unstable isotopes presents several cost, safety, shelf-life and security issues that complicate the use of small-scale fission-based neutron sources. Neutron generators are therefore preferred over fission-based neutron sources for general safety reasons (i.e., because hydrogen isotope sources are relatively stable and non-radioactive), and because of the high cost associated with storing and maintaining radioactive source materials.

FIG. 13 depicts a simplified conventional neutron generator 50 of the type currently utilized in many research facilities. Hydrogen isotope particles (e.g., deuterium gas molecules D₂ and/or tritium gas molecules) are fed from a hydrogen source 51 (e.g., a hydrogen gas supply or a hydrogen getter material) to a plasma ion source 52 for ionization. Plasma ion source 52 may be operably positioned relative to a linear particle accelerator 53 that produces an ion beam 54 by accelerating and directing the ionized hydrogen isotope ions 55 (e.g., deuterons D⁺ and/or tritons) toward the front surface of a target 56. Target 56 is typically a hydrogen absorbing material that is pre-loaded with hydrogen isotope atoms 57 (e.g., substantially stationary deuterium atoms D), and/or may be loaded by hydrogen isotope atoms that are transmitted in ion beam 54 and captured in the hydrogen absorbing material. To minimize the chance of unwanted collisions with random gas molecules, plasma ion source 52 and target 56 are housed in a vacuum chamber 58 that is maintained at a near-vacuum pressure level (e.g., less than 10 Torr). With this arrangement, fusion reactions occur when the path of a high-energy ionized hydrogen isotope atom 55 intersects the fusion cross section of a hydrogen isotope atom 57 and the high-energy hydrogen isotope atom nucleus has enough kinetic energy to tunnel through or overcome the Coulomb repulsion barrier between the two isotopes' positively charged nuclei, whereby the high-energy hydrogen isotope atom nucleus fuses with the nucleus of the hydrogen isotope atom in target 56. As depicted in FIG. 13, the fusion reaction products generated by such fusion reactions involving a high-energy deuteron 55 and a low-energy deuterium atom 57 include an He-3 atom/ion (e.g., ³He²⁺) and a neutron (n) having a kinetic energy of approximately 2.5 MeV.

Current problems associated with the use of conventional small-scale neutron generators include their ability to control neutron production rates (i.e., the rate at which fusion reactions occur) and to deliver neutron rates at low cost in a compact setup for extended periods of time (i.e., greater than 1,000 hours). There are tradeoffs between size, weight and power and neutron rates for specific applications (e.g., stationary vs. portable neutron generators). As explained above, each deuteron-deuterium fusion reaction requires the nucleus of a high-energy deuteron 55 to collide precisely with the nucleus of a deuterium atom 57. The rate of neutron production is generally proportional both to the rate at which high-energy deuterons 55 are transmitted in ion beam 54 (i.e., the ion current) and to the number of deuterium atoms 57 that are within an effective penetration depth d of the target's front surface. That is, each high-energy deuteron 55 loses kinetic energy upon entering the front surface of target 56, and its kinetic energy gradually decreases in proportion to its penetration depth, so its effective penetration depth d (i.e., the penetration depth within which the deuteron retains enough kinetic energy to fuse with a deuterium atom 57) is determined by its kinetic energy. In order to achieve high neutron production rates, commercial neutron generators typically generate deuterons 55 with kinetic energies of about 80 keV, which corresponds to an effective penetration depth of about 100 nm (i.e., collisions with deuterium atoms 57 disposed within about 100 nm of the front surface's terminating atom layer typically generate fusion reactions, but collisions occurring at depths greater than about 100 nm do not). During operation, the rate of neutron production is typically relatively high when target 56 is freshly pre-loaded due to the high number of deuterium atoms 57 present on the near-front surface region of target 56 at the start of a neutron production session. However, the number of deuterium atoms 57 within the effective penetration depth region (i.e., on the near-front surface) of target 56 depends on a balance between the rate at which deuterium atoms are added to target 56 by way of beam-loading (discussed below) and the rate at which deuterium atoms are lost from target 56 due to desorption, sputtering and out-diffusion, as well as fusion reactions. A gradual decrease over time in the number of deuterium atoms 57 on the near-front surface of target 56 leads to gradually decreasing rates of nuclear fusion reactions and, hence, gradually decreasing neutron generation rates.

A conventional technique for maintaining desired nuclear fusion reaction rates involves “beam loading” deuterium atoms 57 into the near-front surface region of target 56 by gradually increasing the flux of high-energy deuterons 55 transmitted in ion beam 54, thereby replenishing at least some of the low-energy deuterium atoms that desorb or are otherwise removed from target 56. That is, some high-energy deuterons 55 that are transmitted by ion beam 54 onto the front target surface become captured in the target material, whereby these captured ions are effectively converted into low-energy deuterium atoms 57. The beam loading technique facilitates nominal nuclear reaction rate control by gradually increasing the amount of hydrogen isotope atoms supplied to plasma ion source 52 and/or increasing the voltage level of particle accelerator source Vpa in order to gradually increase the flux of high-energy deuterons 55 transmitted in beam 54, thereby increasing the number of ions that become captured (loaded) into the front target surface. Unfortunately, the beam loading technique often fails to fully replenish the low-energy deuterium atoms that are lost from the target's front surface, whereby the rate of nuclear fusion reactions (and, hence, neutron generation) typically declines over time.

What is needed is an apparatus/method for sourcing neutrons that addresses the above-mentioned problems associated with conventional neutron sourcing approaches. More specifically, what is needed is a compact, low-cost fusion-based neutron source capable of producing neutrons at a more controllable rate and for a longer period than that achievable using conventional neutron generators and associated techniques.

### SUMMARY OF THE INVENTION

The present invention is directed to an apparatus and improved method for sourcing fusion reaction products (e.g., neutrons and helium atoms or other atomic particles) that utilizes an electrochemical loading process to load low-kinetic-energy (low-k) light element particles into a light-element-absorbing target electrode while directing high-kinetic-energy (high-k) light element particles onto the target electrode. In one embodiment the electrochemical loading process is achieved using an electrochemical cell that is configured to maintain contact between an electrolyte solution and a surface of the target electrode while an electrochemical bias (i.e., either a bias voltage or bias current) is applied to the electrolyte solution such that low-k light element particles are continuously absorbed from the electrolyte solution into the target electrode. Once absorbed, the low-k light element particles diffuse throughout the light-element-absorbing material, thereby loading the target electrode with low-k light element particles. A particle accelerator (e.g., an ion source or plasma ion source) is utilized to accelerate and direct high-k light element particles against the target electrode, with each high-k light element particle having sufficient energy to generate a fusion reaction when it operably collides with an associated low-k light element particle disposed on or in the target electrode. By utilizing the electrochemical loading process to continuously replenish the low-k light element particles that exit the target electrode (i.e., by way of desorbing out of the target electrode or by being fused with associated high-k light element particles), the present invention facilitates substantially longer uninterrupted fusion-reaction-product sourcing operations than those achievable by conventional apparatuses and approaches. Moreover, the electrochemical loading process requires only a small bias voltage/current to maximize the number of absorbed low-k light element particles in the target electrode while facilitating a substantial reduction in the power required to accelerate the high-k light element particles, whereby the apparatus requires substantially less power (i.e., in comparison to conventional beam loading approaches) to achieve high nuclear reaction product sourcing rates.

In some embodiments the target electrode comprises a thin layer of electrically conductive light-element-absorbing material (e.g., a metal foil having a thickness in the range of 0.1 mm to 1 mm), with high-k light element particles being directed onto a frontside (first) surface of the target electrode while the electrochemical loading process is performed through the opposing backside (second) surface of the target electrode. This backside-to-frontside diffusion arrangement achieves high nuclear fusion reaction rates by efficiently and continuously sourcing low-k light element particles to large target electrode frontside surface regions while simultaneously directing high-k light element particles against the frontside surface. That is, by forming the target electrode using an electrically conductive material and applying the electrochemical bias (i.e., either a bias voltage or bias current) between the electrolyte solution the target electrode while the electrolyte solution contacts the entire backside target electrode surface, low-k light-element particles are driven from the electrolyte solution to the target electrode and absorbed through the entire surface area of the backside surface. By further forming the target electrode as a thin plate (e.g., wafer or cylindrical wall-like structure) of light-element-absorbing material, each absorbed low-k light element particle is then required to diffuse a minimal distance from its absorption point on the backside surface to an opposing point on the wall-like frontside surface, whereby the backside-to-frontside diffusion arrangement minimizes the time required to effectively load the target electrode with low-k light element particle. In addition, by way of utilizing a plasma ion source or other particle accelerator capable of directing high-k light element particles onto the entire wall-like frontside surface, the backside-to-frontside diffusion arrangement further facilitates efficient fusion reaction product sourcing operations by maximizing the number of potential collisions between high-k and low-k light element particles. In addition, the liquid/solid contact between the electrolyte solution and the target's backside surface enables higher neutron production rates by facilitating the efficient transfer of heat from the target electrode to the electrolyte solution. That is, the target's frontside surface temperature varies in proportion to the ion power/flux (i.e., the rate of high-k light element particles directed against the frontside surface), and the rate of desorption of low-k light element particle from the frontside surface varies in proportion to the frontside surface temperature. By utilizing the liquid/solid heat transfer mechanism to draw heat away from frontside surface, the present invention achieves lower frontside surface temperatures for a given ion beam power/flux level than is achievable using conventional methods, thereby facilitating higher neutron production rates by reducing the desorption rate of low-k light element particle from the target's frontside surface.

In some embodiments the electrochemical cell includes an electrochemical anode that is immersed in or otherwise operably contacts the electrolyte solution and is coupled to a bias source to apply the electrochemical bias (i.e., either a bias voltage or a bias current) between the target electrode and the electrochemical anode. Note that, in this arrangement, the target electrode effectively forms an electrochemical cathode of the electrochemical cell. By forming the target electrode using a material that is both electrically conductive and light-element-absorbing (e.g., hydrogen permeable) and by configuring the electrochemical anode to optimize the generated bias force, a small (e.g., few volts) applied bias voltage or bias current is sufficient to initiate the electrochemical loading process by efficiently driving low-k light element particles from the electrolyte solution to the target electrode's backside surface such that the low-k light element particles then diffuse through the target electrode to the opposing frontside (first) surface, thereby enhancing the fusion reaction process by continuously refreshing the supply of low-k light element particles disposed on the frontside (first) surface. Further, the inventors bel the rate of fusion reactions (e.g., the rate of neutron generation) varies (i.e., increases or decreases) in direct proportion to corresponding variances in diffusion rate of low-k light element particles through the target electrode, and that the diffusion rate varies in proportion to corresponding variances the applied bias level. Accordingly, in one embodiment the electrochemical cell further includes a bias control device configured to facilitate user-controllable adjustments to the electrochemical bias's voltage/current level by way of an externally applied bias control signal, thereby providing a novel technique for controlling the rate of fusion reactions generated by a host fusion reaction product sourcing apparatus that represents a substantial improvement over the fusion reaction rate control achievable using conventional beam loading techniques.

In presently preferred embodiments the apparatus is configured for nuclear reactions involving hydrogen isotopes (e.g., deuterium and/or tritium). In some practical embodiments, the low-k light element particles are deuterium atoms supplied from a suitable electrolyte solution (e.g., aqueous sulfuric acid in heavy water), the high-k light element particles are deuterons, the target electrode comprises a metal foil comprising palladium and having a thickness in the range of 0.1 mm to 1 mm. In other embodiments the Pd foil may be configured to function both as a target electrode that absorbs/diffuses tritium particles from a tritium-based electrolyte solution, and also as a filter that prevents the diffusion of contaminant ³He atoms, which naturally arise due to T decay, from entering the vacuum chamber. In alternative embodiments the target electrode may be a lithium absorbing material (e.g., LiCoO₄) and the low-k light element atoms comprise lithium isotope atoms—when bombarded with energetic protons, the lithium containing target electrode could prove useful for the study of an astrophysical process known as lithium burning. In such an application, the electrochemical anode would likely comprise graphite or silicon.

In some embodiments the particle accelerator and at least a portion of the target electrode that includes frontside surface are maintained by a vacuum system in a low-pressure (e.g., approximately 10 Torr or less) rarified atmosphere including light element gas molecules (e.g., D₂ and/or T₂). In some embodiments the electrochemical cell includes a housing structure that forms a vacuum-tight seal around the target electrode such that the frontside surface is exposed to the low-pressure rarified atmosphere and the backside surface and electrolyte solution are subjected to substantially atmospheric pressures (i.e., approximately 760 Torr). In some embodiments the particle accelerator is implemented using a plasma ion source having a counter electrode configured to produce a glow plasma discharge, which may also be an electrically pulsed plasma discharge, between the counter electrode and the target electrode. When implemented within the low-pressure rarefied atmosphere, the plasma discharge ionizes the light element gas molecules, and accelerates the resulting dissociated ions to provide the high-k light element particles directed toward the first surface of the target electrode. An advantage provided by this arrangement is that the requisite light element gas molecules may be entirely supplied by low-k light element particles that have diffused entirely through the target electrode and detached from the frontside surface into the vacuum chamber, which facilitates substantially reducing the overall size and cost of a nuclear generator unit in some embodiments by way of eliminating the need for an expensive and bulky hydrogen source (e.g., a gas bottle or getters). In addition, the density of the electrolyte solution is over 1000 denser than hydrogen gas and a few ml of the electrolyte solution can contain more hydrogen atoms than in present in a gas cylinder (few liter volume), as well as more hydrogen atoms than present in a hydrogen get compound (commonly used to provide hydrogen isotopes for sealed neutron generators). Hence the electro-chemical solution provides a much more compact and low-cost source of hydrogen isotopes. In other embodiments the supply of requisite light element gas generated by the targeted (first) electrochemical cell may be supplemented using conventional techniques (e.g., supplying D₂ and/or T₂ gas from a hydrogen gas bottle or hydrogen getters), or may be supplemented using a non-targeted (second) electrochemical cell that is configured to supply light element gas molecules using the same process utilized by the targeted electrochemical cell.

In some exemplary practical embodiments the apparatus is configured such that the target electrode and the electrochemical cell are inserted through an upper flange into a primary vacuum chamber, and the plasma ion source (particle accelerator) is inserted through a lower flange into the primary vacuum chamber. In one exemplary specific embodiment the target electrode is a tube-shaped structure formed substantially entirely of light-element-absorbing material that contains the electrolyte solution and is mounted onto an upper flange of the vacuum chamber such that a first (e.g., closed-end) portion is disposed inside the vacuum chamber and a second (e.g., opened-end) portion is disposed outside of the vacuum chamber. In this embodiment the plasma ion source includes a cylindrical counter electrode that surrounds an outer cylindrical surface of the tube-shaped target electrode. This tube-shaped configuration potentially increases neutron generation for a given vacuum chamber size by generating a cylindrical plasma discharge that supplies high-k light element particles to the entire outer cylindrical surface of the tube-shaped target electrode. In another exemplary embodiment the electrochemical cell includes a cylindrical housing containing electrolyte solution and the target electrode is a disk-shaped wafer that is secured to a first (closed) end portion of the cylindrical housing that is disposed inside the vacuum chamber, and the plasma ion source includes a disk-shaped counter electrode that is positioned such that a disk-shaped plasma discharge is generated between the disk-shaped counter electrode the target electrode. This disk-shaped configuration is presently considered less expensive to produce and maintain than the tube-shaped configuration. In an alternative exemplary embodiment the electrochemical cell includes both a counter electrode (electrochemical anode) and a reference electrode disposed in contact with the electrolyte solution. In another alternative exemplary embodiment the electrochemical cell utilizes a recombiner to ensure that hydrogen sourced from the electrolyte is not lost due to the evolution of hydrogen gas at the target electrode.

In other embodiments the apparatus includes one or more reaction product detecting systems to measure fusion reaction products for purposes of achieving possible breakthroughs in the field of nuclear fusion science. That is, fusion reaction rates are determined by the kinetic energy of the reaction partners (a kinetic energy of 1 keV equals a temperature of about 10 million degrees). Achieving energy gain from fusion requires very hot, dense and well-confined plasmas that are difficult and expensive to produce. The inventors have observed that fusion reactions at a few keV can be enhanced 100-fold when the reactions take place in metals, as compared to reactions taking place in gas phase. Preliminary experimental results generated by the methods and system described above (i.e. where fusion reactions occur in a metal such as palladium) indicate possibly significant changes to the presently understood branching ratio of deuterium-deuterium fusion reactions, indicating the discovery of potentially new nuclear processes. If these preliminary experimental results are confirmed and the underlying mechanisms of these new nuclear processes can be understood, then implementation of the present invention could lead to fusion energy without the need for very hot plasmas (i.e., without fulfilling the Lawson criteria), thereby providing a path to low cost, carbon free electricity. Accordingly, any of the various apparatus configurations mentioned above may be further enhanced to facilitate the potential discovery of significant breakthroughs in the field of nuclear fusion science by way of including one or more reaction product detecting systems (e.g., at least one of a residual gas analyzer, a mass spectrometer, a neutron detector, a charged particle detector and a gamma ray detector that is/are operably configured to detect fusion reaction products generated by fusion reactions occurring in the target electrode). In addition, the invention can support the path to fusion power with hot, dense and well-confined plasmas by providing a technique for low cost tritium recovery and purification.

### BRIEF DESCRIPTION OF THE DRAWINGS

These and other features, aspects and advantages of the present invention will become better understood with regard to the following description, appended claims, and accompanying drawings, where:

FIG. 1 is a cross-sectional side view showing a simplified generalized apparatus for sourcing nuclear fusion products according to a generalized embodiment of the present invention;

FIG. 2 is a flow diagram depicting a generalized method for sourcing nuclear fusion products according to an embodiment of the present invention;

FIG. 3 is a cross-sectional side view showing a simplified apparatus for sourcing nuclear fusion products according to a specific embodiment of the present invention;

FIG. 4 is a cross-sectional side view showing a simplified apparatus for sourcing nuclear fusion products according to a specific embodiment of the present invention;

FIG. 5 is a cross-sectional side view showing a simplified apparatus for sourcing nuclear fusion products according to yet another specific embodiment of the present invention;

FIG. 6 is a perspective view showing a simplified apparatus for sourcing nuclear fusion products according to yet another specific embodiment of the present invention;

FIG. 7 is a cross-sectional side view showing a simplified apparatus for sourcing nuclear fusion products according to a specific embodiment of the present invention;

FIG. 8 is a cross-sectional side view showing a simplified apparatus for sourcing nuclear fusion products according to a specific embodiment of the present invention;

FIG. 9 is a cross-sectional side view showing a electrochemical cell of an apparatus for sourcing nuclear fusion products according to another specific embodiment of the present invention;

FIG. 10 is a cross-sectional side view showing a electrochemical cell of an apparatus for sourcing nuclear fusion products according to yet another specific embodiment of the present invention;

FIGS. 11A and 11B are simplified front and top schematic views, respectively, showing an apparatus for sourcing nuclear fusion products according to yet another specific embodiment of the present invention;

FIG. 12 is a simplified wiring diagram depicting electrical connections utilized by the apparatus of FIGS. 11A and 11B; and

FIG. 13 is a cross-sectional side view showing a generalized conventional neutron generator.

### DETAILED DESCRIPTION OF THE DRAWINGS

The present invention relates to an improvement in methods and apparatus/systems for sourcing nuclear fusion products. The following description is presented to enable one of ordinary skill in the art to make and use the invention as provided in the context of a particular application and its requirements. As used herein, directional terms such as “downward”, “front”, “back”, “frontside”, “backside”, “upper” and “lower” are intended to provide relative positions for purposes of description and are not intended to designate an absolute frame of reference. Various modifications to the preferred embodiment will be apparent to those with skill in the art, and the general principles defined herein may be applied to other embodiments. Therefore, the present invention is not intended to be limited to the embodiments shown and described but is to be accorded the widest scope consistent with the principles and novel features herein disclosed.

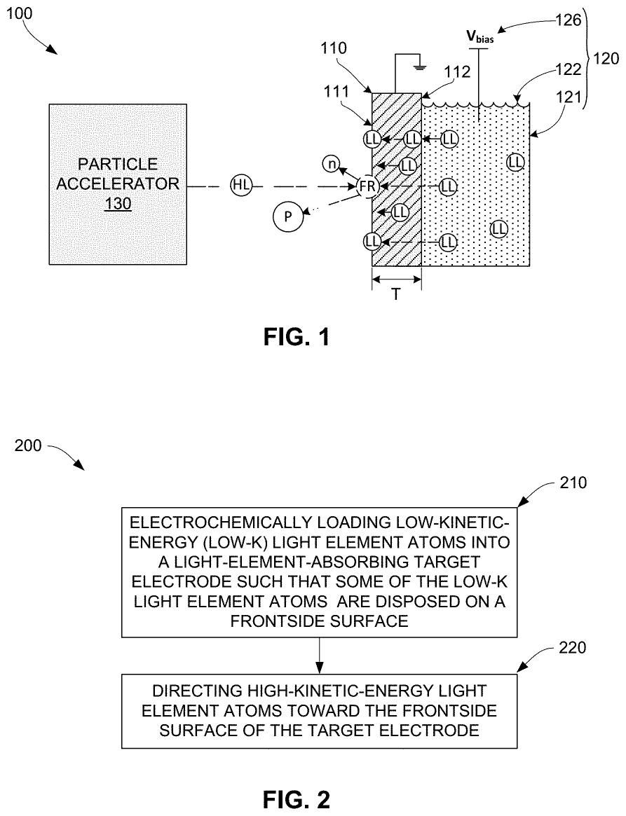

FIG. 1 depicts a simplified and generalized fusion reaction product sourcing apparatus 100, and FIG. 2 is a simplified flow diagram showing a generalized method 200 for sourcing nuclear fusion products. As indicated in FIG. 1, generalized fusion reaction product sourcing apparatus 100 includes a target electrode 110, an electrochemical cell 120 and a particle accelerator 130. Although method 200 is described below with reference to operations performed using apparatus 100, it is understood that the associated methodology is not necessarily restricted to operations performed by the specific structures of apparatus 100.

Referring to FIG. 1, target electrode 110 is characterized by being formed of a material that is light-element-absorbent (i.e., receptive and permeable to atoms of one or more target light elements) and preferably electrically conductive. For example, in practical embodiments described below, hydrogen isotope (e.g., deuterium and/or tritium) ions and atoms are designated light element particles, and target electrode 110 comprises palladium (Pd), which is hydrogen permeable and also electrically conductive, and is therefore light-element-absorbing with respect to the designated light element particles (i.e., D and T). In other embodiments the light element may be selected from the group of boron, beryllium, or lithium, or a hydride of a light element (e.g., lithium hydride), in which case the target electrode 110 may comprise a suitable material that exhibits permeability to the atoms of the selected light element. In some embodiments, electrode 110 is a thin wafer or plate-like structure having a frontside (first) surface 111 that faces away from electrochemical cell 120 and toward particle accelerator 130, and a backside (second) surface 112 that faces toward at least a portion of electrochemical cell 120. Note that the structural dimensions depicted in the figures are intentionally and significantly distorted for illustrative purposes. For example, a thickness dimension T of electrode 110 may be substantially smaller (i.e., relative to its lateral dimensions) than that depicted in the figures. in other embodiments electrode 110 may be a solid (e.g., block-like) structure.

The present invention is described herein with reference to certain generalized phrases that are used for brevity and convenience. For example, the description references fusion reactions involving collisions between two “light element particles” that occur “on a frontside surface” (e.g., frontside surface 111 of target electrode 110). In the context of a given fusion reaction, the phrase “light element particle” refers to the colliding light element atoms or ions (e.g., a deuteron colliding with a deuterium atom), and the phrase “on a frontside surface” is intended to mean a location that is either on the outermost layer of atoms that technically define the corresponding surface, or a near-surface location that within a distance of approximately 100 nm from the outermost atomic layer. In other contexts, the phrase “light element particle” may refer to such light element atoms or ions as part of a larger molecule (e.g., light element particles LL disposed in electrolyte solution 122 may be part of a polyatomic ion such as hydronium (H30+) or ammonium (NH₄⁺)).

Referring to FIG. 2, method 200 includes electrochemically loading low-kinetic-energy (low-k) light element particles into a target electrode such that some of the low-k light element particles are disposed on a frontside surface of the target electrode (block 210). Referring to the right side of FIG. 1, this electrochemical loading process is performed by apparatus 100 using an electrochemical cell 120 including an electrolyte solution 122 and a bias voltage source 126 that is configured to apply a bias voltage (electrochemical bias) V_{bias} to electrolyte solution 122. Electrolyte solution 122 is a liquid-state substance including low-kinetic-energy (low-k) light element particles LL that is contained or otherwise disposed such that electrolyte solution 122 contacts backside surface 112 of target electrode 110. For example, when the designated light element is deuterium, electrolyte solution 122 may comprise an electrolyte containing hydrogen such as aqueous D₂SO₄ in D₂O. Electrochemical bias source 126 applies bias voltage (potential) V_{bias} to electrolyte solution 122 in order to drive low-k light element particles LL disposed in electrolyte solution 122 to backside surface 112, thereby causing these driven low-k light element particles to be absorbed into target electrode 110. In some embodiments target electrode 110 functions as the cathode of electrochemical cell 120 (i.e., anode 124 is biased positive relative to target electrode 110). The absorbed low-k light element particles diffuse (migrate) through target electrode 110 from backside surface 112 and become disposed on frontside surface 111. In this way, low-k light element particles LL are continuously sourced to frontside surface 111 while anode is biased positive relative to target electrode 110.

Referring again to FIG. 2, method 200 also includes directing high-kinetic-energy (high-k) light element particles toward the target electrode (block 220). Referring to the left side of FIG. 1, this high-k directing process is performed using particle accelerator 130, which utilizes known techniques to accelerate and direct high-k light element particles HL toward frontside surface 111 of target electrode 110 with sufficient energy to produce fusion reactions (FR) whenever a given high-k light element particle HL operably collides with an associated low-k light element particle LL disposed on frontside surface 111. That is, particle accelerator 130 functions to accelerate light element particles (e.g., deuterons) to a suitable energy level (i.e., approximately 1 kV or higher), with the accelerating force being applied in a direction that causes the high-k light element particles HL to strike frontside surface 111. An operable collision occurs when the path of a high-k light element particle HL intersects the fusion cross section of an associated low-k light element particle LL that is disposed on frontside surface 111, and the kinetic energy of the high-k light element particle HL is sufficient for its nucleus to tunnel through (or to overcome) the Coulomb repulsion barrier between the two isotope's positively charged nuclei, whereby the nucleus of high-k light element particle HL fuses with the nucleus of low-k light element particle LL. These operable collisions generate fusion reactions FR that produce neutrons (n) and other particles (P) as fusion reaction products.

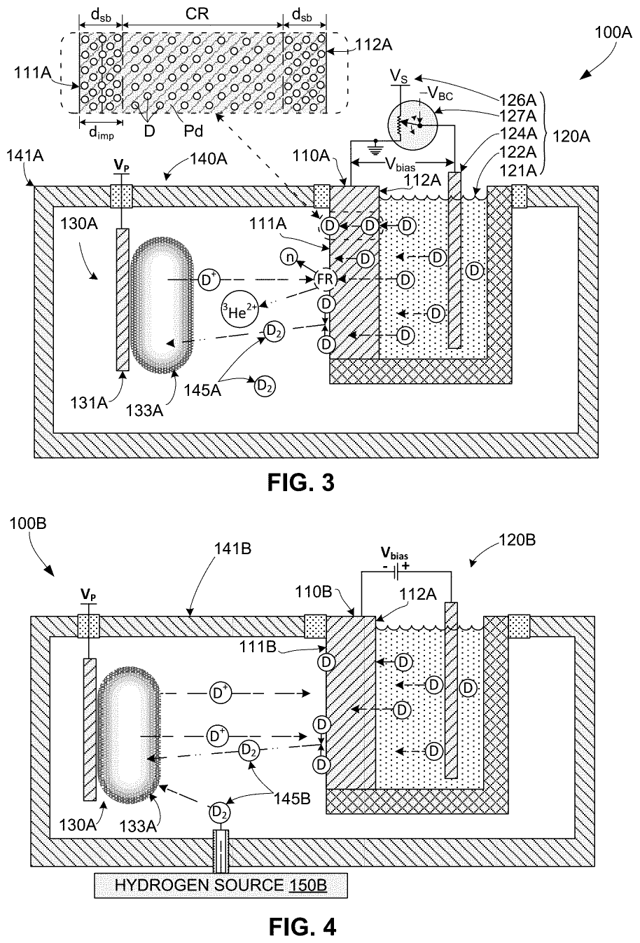

FIG. 3 depicts an apparatus 100A including a target electrode 110A, an electrochemical cell 120A and an ion source (particle accelerator) 130A that are configured and function in the manner described above with reference to FIG. 1. As set forth below, apparatus 100A includes several additional structures and features that facilitate fusion reactions involving the hydrogen isotopes deuterium and tritium. While these structures and features are mainly described with specific reference to deuterium-deuterium fusion reactions, these structures and features may also beneficially enhance operations involving other fusion reaction types (e.g., proton-Boron). In addition, those skilled in the art will recognize that the structures and features described with reference to FIG. 3 may be implemented in any embodiment described herein.

This invention comprises an electrochemical cell comprising an electrochemical anode, an electrochemical reference electrode, an electrolyte containing hydrogen such as aqueous D₂SO₄ in D2O, and a hydrogen permeable cathode such as a palladium foil (between 0.1 and 1 mm thick). A controllable electrochemical potential bias between the electrochemical anode and the cathode (anode biased positive relative to the cathode) leads to the entry of hydrogen from the electrolyte into the cathode at a first cathode surface corresponding to the interface between the electrolyte and the cathode. Once absorbed at the first cathode surface, hydrogen diffuses throughout the thickness of the cathode and reaches a second cathode surface within a vacuum chamber. Hydrogen at and near (within approximately 100 nm) the second cathode surface serves as a target for bombardment with energetic light elements to produce fusion reactions.

According to a presently preferred embodiment, apparatus 100A is implemented using deuterium (D) as the designated light element (e.g., where electrolyte solution 122A is aqueous D₂SO₄ in D₂O), and target electrode 110A is implemented using a palladium foil structure having a thickness in the range of 0.1 mm to 1 mm. Using these parameters, a previously unrecognized feature that led to the present invention is the similarity of two critical length scales underlying the physical process that takes place on frontside surface 111A, where D-D fusion reactions FR occur. Referring to the dashed-box section near the top of FIG. 3, these two length scales include an effective implantation depth dᵢₘₚ of high-k deuterons D⁺ that impinge on frontside surface 111A, and a strong-binding depth d_{sb} inside the outermost atomic layers of a Pd foil in which deuterium atoms D are relatively densely packed. The effective implantation depth dᵢₘₚ represents an average depth that a high-k deuterium particles can penetrate into the Pd foil while retaining sufficient energy to generate a fusion reaction, and is on the order of 1 nm to 10 nm for deuterons with kinetic energy on the order of 1 kV in palladium (i.e., high-k deuterium particles that penetrate beyond this depth typically lose too much kinetic energy to fuse with a low-k deuterium particle). The strong-binding depth d_{sb} defines a layer/region near frontside surface 111A and backside surface 112A within which the density of deuterium atoms is relatively high, as compared with a lower density of deuterium atoms disposed in an intervening central region CR. That is, low-k deuterium particles are relatively densely packed immediately after being absorbed through backside surface 112A, then become less densely packed as they diffuse from backside surface 112A toward frontside surface 111A, and then become more densely packed as they move within strong-binding depth d_{sb} of frontside surface 111A. The strong-binding depth d_{sb} for a palladium-foil-type target electrode 110A is on the order of several atomic layers, which is coincidentally on same order (1 nm to 10 nm) as implantation depth dᵢₘₚ for deuterium ions with kinetic energy of 1 keV in Pd. This means that the use of a palladium target electrode in conjunction with the electrochemical loading process of the present invention provides a continuously replenishment of high-density deuterium particles precisely where they are needed to maximize the probability of achieving high fusion reaction rates using deuterium ions with kinetic energy of 1 keV. That is, the present inventors recognized that the tendency for hydrogen isotopes to absorb preferentially at the surface of palladium (and other metals) could be exploited in this invention to create a hydrogen rich target surface that is continuously replenished by the electrochemical process, thereby facilitating substantially higher (i.e., 100×) neutron generation rates using deuterons having kinetic energies of 1 keV. Of course, this enhanced neutron generation rate may be increased by way of configuring particle accelerator 130A to accelerate incident deuterons to higher kinetic energies, thereby increasing the effective penetration depth region to include both the high-density deuterium atoms located within strong-binding depth d_{sb} and lower density deuterium atoms located further from frontside surface 111A. For example, utilizing deuterons with kinetic energies of 80 keV yield over a million times higher neutron generation rates than those generated by 1 keV deuterons (i.e., by increasing the effective penetration depth to 100 nm). Referring to the right side of FIG. 3, electrochemical cell 120A includes a containment housing 121A that maintains electrolyte solution 122A in contact with a backside surface 112A, and an electrochemical anode (counter electrode) 124A that applies an electrochemical bias (i.e., either a small bᵢₐₛ voltage V_{bias} on the order of one to five volts, or a comparable bias current) between target electrode 110A and electrochemical anode 124A such that low-k deuterium particles D are driven from electrolyte solution 122A through backside surface 112A into target electrode 110A. In one embodiment the electrochemical cell 120A further includes a bias control device 127A configured to facilitate user-controllable adjustments of bias voltage V_{bias} level by way of an externally applied bias control signal V_{BC}, thereby allowing a user to control the rate of fusion reactions generated by apparatus 100A by way of selectively varying the level bias voltage V_{bias}.

Referring to the left side of FIG. 3, particle accelerator 130A and at least a portion of target electrode 110A (i.e., including frontside surface 111A) are maintained by a vacuum system 140A in a low-pressure (e.g., approximately 10 Torr or less) rarified atmosphere made up of light element gas molecules (e.g., D₂ and/or T₂). Electrochemical cell 120A includes a housing structure 121A that supports target electrode 110A and is operably connected to a vacuum chamber 141A of vacuum system 140A such that frontside surface 111A is exposed to the rarified atmosphere, and such that backside surface 112A and electrolyte solution 122A are subjected to substantially atmospheric pressure (i.e., approximately 760 Torr). In some embodiments, particle accelerator 130A is implemented using a plasma ion source 130A having a counter electrode 131A configured to produce a glow plasma discharge 133A, which may also be an electrically pulsed plasma discharge, between counter electrode 131A and target electrode 110A. When implemented within vacuum chamber 141A, a flux of D₂ gas released from frontside surface 111A into vacuum chamber 141A then feeds plasma discharge 133A, whereby electrochemical cell 120A serves as a source of high-k deuterons. That is, plasma discharge 133A ionizes the D₂ gas molecules released from target electrode 110A and accelerates the resulting dissociated high-k deuterons D⁺ toward frontside surface 111A of target electrode 110A. An advantage provided by this arrangement is that light element gas molecules 145B (e.g., D₂) may be entirely supplied by low-k deuterium particles sourced from electrochemical cell 120A, which facilitates substantially reducing the overall size and cost of apparatus 100A by way of eliminating the need for an expensive and bulky external hydrogen source.

In some embodiments that utilize low-k tritium particles (e.g., a neutron generator that utilizes the reaction D+T→n+⁴He), a palladium foil target electrode may also function as a filter (i.e., in addition to sourcing low-k tritium to the target electrode's frontside surface). Devices of this sort have the problem in that tritium decays naturally into ³He (plus a neutrino) with a half-life of approximately twelve years, with the unwanted result that the supply of tritium gradually becomes contaminated with ³He. In the existing art, neutron generators of this type may have a sealed vacuum chamber containing T₂ gas in which the accumulating ³He is difficult to remove. Using the electrochemical loading process of the present invention, if the electrolyte solution includes tritium particles (e.g., a a solution of T₂SO₄ in T₂O), then ³He from continuous tritium decay would collect in the electrolyte solution 122, but would be prevented from passing through the target electrode to the vacuum chamber. This is because certain materials, such as Pd, readily support the diffusion of hydrogen; but not helium. Therefore, the ³He particles stay behind in the electrolyte solution, thereby preventing contamination of the vacuum chamber. In potential embodiments such a filtered source of pure T might be utilized in a long duration space missions, or a long service life neutron generator. In addition, this filter source can be used for tritium recovery and purification in a plasma based fusion reactor and other fusion devices.

FIG. 4 shows an apparatus 100B according to an alternative embodiment in which the supply of requisite light element gas molecules 145B (e.g., D₂) in the rarified vacuum chamber atmosphere is supplemented using a hydrogen source 150B (e.g., a hydrogen gas bottle or hydrogen getters). That is, an electrochemical cell 120B and a target electrode 110B are operably connected to a vacuum chamber 141B in the manner described above such that high-k light element particles (e.g., deuterium ions D⁺) directed from ion source 130B impinge on frontside surface 111B with sufficient energy to produce fusion reactions. As described above, some of the requisite light element gas molecules 145B are sourced by low-k light element particles that detach from frontside surface 111B. In cases where the supply of light element gas molecules 145B generated in this manner is insufficient, neutron generation by apparatus 100B may be beneficially enhanced by way of providing hydrogen source 150B.

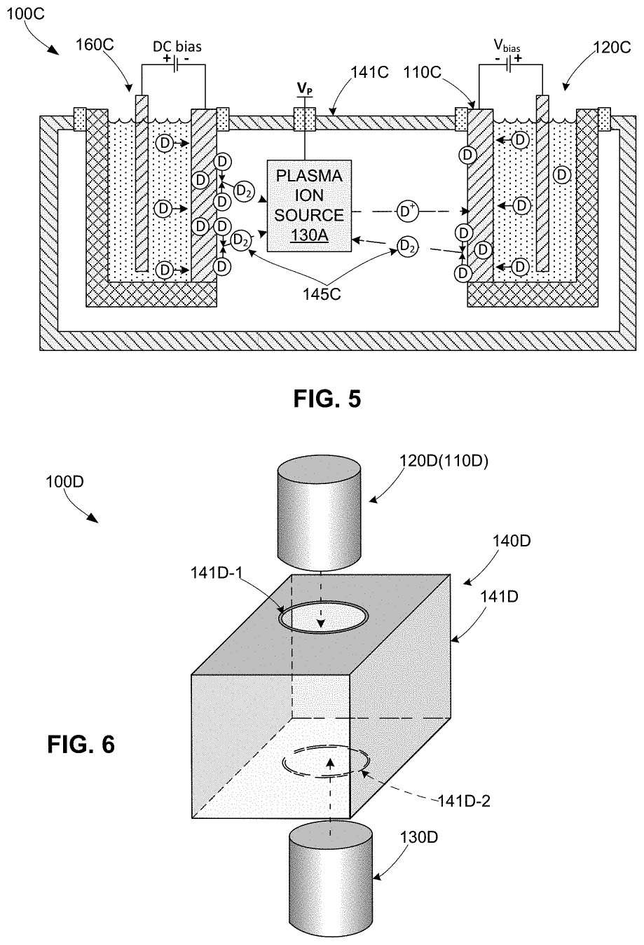

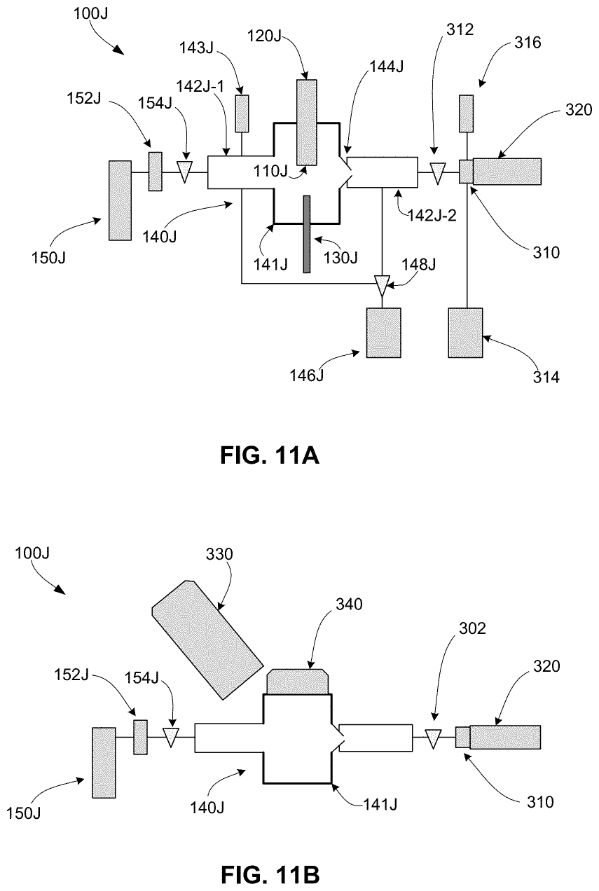

FIG. 5 shows an apparatus 100C according to another exemplary embodiment in which a dual electrochemical cell setup is utilized both as a source of high-k light element particles and to supply low-k light element particles to a target electrode 110C. A first electrochemical cell 120C is configured and operates as described above to source low-k light element particles D to the frontside surface of a target electrode 110C (e.g., by electrochemically driven deuterium transport through Pd), whereby fusion reactions are generated by collisions with high-k light element ions D⁺ directed onto target electrode 110C by plasma ion source 130A. Vacuum chamber 141C is also outfitted with a second electrochemical cell 160C comprising a cathode 161C, an electrolyte solution 162C and an anode 163C, where cathode 161C is a thin Pd foil approximately 0.1 mm to 1 mm thick having a first (backside) surface in contact with electrolyte solution 162C and a second (frontside) surface in contact with the contents of vacuum chamber 141C. When cathode 161C is subjected to a small negative DC bias (0 to 5 Volts), deuterium diffuses through the Pd foil and forms D₂ gas molecules into vacuum chamber 141C in a manner similar to that described above. In one embodiment, a pump is connected to vacuum chamber 141C through a valve (e.g., as described below with reference to FIG. 11A), whereby the operating pressure of D₂ gas molecules 145C in vacuum chamber 141C can be controlled by throttling the valve to establish a dynamical vacuum in the chamber. With this arrangement, plasma ion source 130A is supplied with D₂ from electrochemical cell 160C. In one embodiment, plasma ion source 130A comprises a hot filament that ionizes D₂ gas in vacuum chamber 141C, and an ion accelerator configured to generate an electric field that accelerates and directs the D ions toward target electrode 110C. Other plasma ion source types, including RF and microwave driven ion sources can also be embodied.

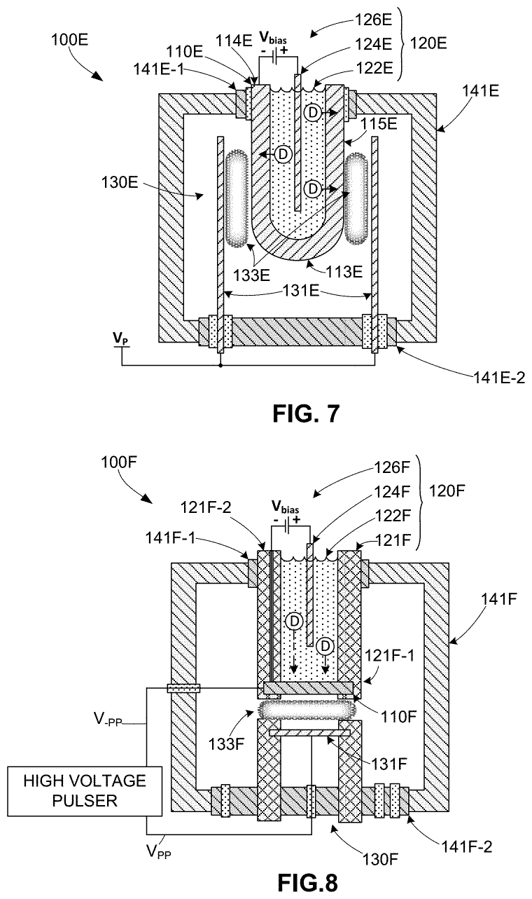

FIG. 6 shows a simplified apparatus 100D in which electrochemical cell 120D and plasma ion source (particle accelerator) 130D are disposed in an over/under configuration. Apparatus 100D includes a vacuum system 140D having a primary vacuum chamber 141D having an upper flange/opening 141D-1 and a lower flange/opening 141D-1. Electrochemical cell 120D, to which target electrode 110D is operably coupled using details provided below, is operably configured (i.e., has a substantially cylindrical shape and size) for partial insertion into vacuum chamber 141D through upper flange/opening 141D-1. Similarly, plasma ion source 130D is operably configured for partial inserting through lower flange/opening 141D-2 into vacuum chamber 141D. As described below with reference to the specific embodiments shown in FIGS. 7 to 10, this over/under configuration facilitates optimal positioning between target electrode 110D and plasma ion source 130D with minimal effort.

FIG. 7 shows an apparatus 100E that represents a first embodiment of the over/under configuration described with reference to FIG. 6. Apparatus 100E is characterized by having a tube-shaped target electrode 110E that forms a containment structure for electrochemical cell 120E, and by having a plasma ion source 130E including a cylindrical plasma electrode 131E disposed around tube-shaped target electrode 110E. More specifically, target electrode 110E includes an electrically conductive light-element-absorbing material (e.g., Pd) that is machined or otherwise formed into a tube-shaped structure having a lower closed-end portion 113E, an opened-end portion 114E, and a cylindrical central portion 115E extending between lower closed-end portion 113E and opened-end portion 114E. Target electrode 110E is fixedly connected to an upper flange 141E-1 of a vacuum chamber 141E such that a portion of cylindrical central portion 115E including closed-end portion 113E extends into vacuum chamber 141E, and such that opened-end portion 114E is disposed outside of vacuum chamber 141E. Electrochemical cell 120E includes an electrolyte solution 122E that is contained within tube-shaped target electrode 110E such that it contacts a cylindrical inside (backside) surface of cylindrical central portion 115E, an electrochemical anode 124E disposed in contact with electrolyte solution 122E, and a bias source 126E. During operation bias source 126E is actuated to apply a bias voltage V_{bias} between electrochemical anode 124E and tube-shaped target electrode 110E, thereby causing low-k light element particles (e.g., deuterium particles D) to migrate out of electrolyte solution 122E through the cylindrical inside surface of cylindrical central portion 115E and become disposed on a cylindrical outer surface of cylindrical central portion 115E in a manner similar to that described above. Plasma ion source 130E is fixedly connected to a lower portion of vacuum chamber 141E such that cylindrical plasma electrode 131E surrounds the cylindrical inside surface of cylindrical central portion 115E. During operation, a suitable high voltage signal Vₚ is applied to generate a cylindrical plasma discharge region 133E between cylindrical plasma electrode 131E and tube-shaped target electrode 110E, thereby directing high-k light element particles against the entire outer cylindrical surface of tube-shaped target electrode 110E. Apparatus 100E is therefore able to increase neutron generation for a given vacuum chamber size by providing a substantially larger fusion reaction area than can be achieved using the disk-shaped electrodes approaches described below.

FIG. 8 shows an apparatus 100F representing a second over/under configuration characterized by having a disk-shaped target electrode 110F that is fixedly attached to an electrochemical cell 120F, and by having a plasma ion source 130F including a disk-shaped counter electrode (vacuum anode) 131F that is positioned to generate a disk-shaped plasma discharge region 133F that directs high-k light element particles onto a downward-facing (frontside) surface of target electrode 110F. Chemical cell 120F includes a cylindrical housing 121F comprising an inert, dielectric plastic and having a lower, closed-end portion 121F-1 and an opposing upper opened-end portion 121F-2. Cylindrical housing 121F is fixedly connected to an upper flange 141F-1 of a vacuum chamber 141F such that lower-end portion 121F-1 is disposed inside vacuum chamber 141F, and such that opened-end portion 121F-2 is disposed outside of vacuum chamber 141F. In a specific embodiment cell 120F includes an electrolyte solution 122F comprising D₂O and D₂SO₄ (deuterated sulfuric acid), and target electrode 110F includes an electrically conductive light-element-absorbing material (e.g., Pd foil having a thickness of 0.1 mm to 1 mm and a diameter of approximately one inch). Target electrode 110F is fixedly attached over a lower (closed) end 121F-1 of cylindrical housing 121F such that a vacuum-tight seal is formed between an interior of vacuum chamber 141F and an interior of cylindrical housing 121F. Electrolyte solution 122F is contained within cylindrical housing 121F such that it contacts an upper (backside) surface of target electrode 110F. Plasma ion source 130F is fixedly connected to a lower vacuum chamber flange 141F-2 and extends into vacuum chamber 141F such that disk-shaped plasma electrode 131F is maintained at a predetermined distance from target electrode 110F. Both upper and lower vacuum flanges 141F-1 and 141F-2 are electrically isolated from the wall of vacuum chamber 141F to facilitate subjecting target electrode 110F to a pulsed negative bias −Vpp with respect to a positive pulsed bias Vpp applied to plasma electrode 131F. This may be accomplished multiple ways, including grounding plasma electrode 131F while sending a negative pulse to target electrode 110F, or by grounding target electrode 110F while sending a positive pulse to plasma electrode 131F. In practical embodiments multiple plasma electrodes 131F are utilized and configured based on a parallel-plate geometry for the anode and cathode, comprising ca 1″ diameter disks for each electrode.

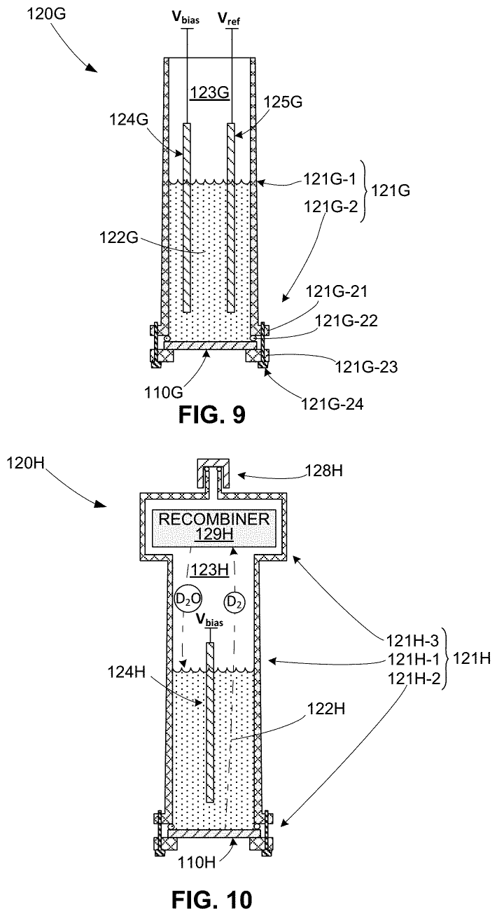

FIG. 9 depicts an electrochemical cell 120G that may be utilized in place of cell 120F in a practical implementation of apparatus 100F (FIG. 7). Cell 120G includes a containment unit 121G having a cylindrical containment housing 121G-1 and a clamping assembly 121G-2 disposed at its lower end, a target electrode 110G that is secured by way of clamping assembly 121G-2 such that an electrolyte solution 122G disposed in a container cavity 123G contacts a backside surface of target electrode 110G. In one embodiment cylindrical containment housing 121G-1 comprises an inert, dielectric plastic (e.g. PEEK) defining a cylindrical volume of approximately 20 ml and is open at its upper end. Clamping assembly 121G-2 includes a clamping flange 121G-21 that is integrally connected to cylindrical containment housing 121G-1, and disk-shaped target electrode 110G is held between one or more rubber (e.g. Viton) O-rings 121G-22 and one or more plastic clamping disks 1221G-23 that are in turn connected by dielectric screws 121G-24. This configuration affords the mechanical support required for operation with a significant pressure differential across target electrode 110G.

According to an aspect of the embodiment shown in FIG. 9, cell 120G includes both a counter electrode 124G and a reference electrode 125G that are disposed (i.e., operably supported) in container cavity 123G such that both electrodes contact electrolyte solution 122G. Counter electrode 124G is configured to apply bias voltage V_{bias} to electrolyte solution 122G, and functions in a manner described in the various embodiments presented above. Reference electrode 125G functions to measure the cell's anode and cathode potentials with respect to a well-known reference potential V_{ref}. Because the varied electrochemical reactions that may occur at the electrodes are voltage dependent, the measurement of electrode potential with respect to a standard reference helps to define each electrode's operating regime. In one embodiment reference electrode 125G has the same construction as counter electrode 124G and is configured to apply reference voltage V_{ref} to electrolyte solution 122G.

FIG. 10 depicts an electrochemical cell 120H according to another exemplary embodiment. Cell 120H is similar to cell 120G (described above) in that it includes a containment unit 121H having a cylindrical containment housing 121H-1 having a clamping assembly 121H-2 disposed at its lower end, and includes a target electrode 110H that is secured by way of clamping assembly 121H-2 such that an electrolyte solution 122H disposed in container cavity 123H contacts a backside surface of target electrode 110H, with an electrochemical anode 124H operably disposed in container cavity 123H such that it applies a bias voltage to electrolyte solution 122H. The composition and/or structure of each of these elements is consistent with corresponding elements described in any of the embodiments set forth above.

Referring the upper portion of FIG. 10, electrochemical cell 120H differs from the previous embodiments in that containment unit 120H further includes an upper containment structure 121H-3 that is configured to effectively seal the upper end of container cavity 123H (i.e., upper containment structure 121H-3 makes container cavity 123H essentially gas-tight, and therefore may include a pressure release mechanism 128H for safety). According to the present embodiment, upper containment structure 120H-3 ensures that light element particles sourced from electrolyte solution 122H are not lost due to the evolution of gas at target electrode (electrochemical cathode) 110H. The release of hydrogen isotope gas molecules (e.g., D₂ and/or T₂) at the interface between electrolyte solution 122H and target electrode 110H is commonly referred to as the hydrogen evolution reaction, or HER. In one embodiment, cell 120H includes a recombiner 129H that is configured to catalyze the recombination of hydrogen isotope gas from the HER process with oxygen, thereby generating heavy water that is then returned to electrolyte solution 122H. In another embodiment, the level of bias voltage V_{bias} is maintained at a sufficiently low magnitude to avoid the production of significant gas by the HER process. In another embodiment, electrolyte solution 122H includes one or more additives that function to suppress the HER process (e.g., water-in-salt electrolytes are designed to coordinate each water molecule with surrounding salt ions, thereby reducing each water molecule's availability to participate in the HER process at target electrode's surface).

Although the present invention is described above with specific reference to neutron generators, the present invention may also be beneficially utilized in a broader application as a tool for discovering and controlling new energy efficient ways to enhance nuclear reaction rates. Specifically, in addition to increased neutron generation, the enhanced fusion reaction rates achieved by way of combining electrochemistry and low energy ion sources also increases the production rate of other fusion reaction products, and the study of these other fusion reaction products may lead to a significantly greater understanding of both fusion and fission reactions. As such, by modifying the basic apparatus arrangements described above to include one or more reaction product detecting systems that are operably configured to detect and measure the fusion reaction products, beneficial aspects of the present invention may expanded from merely sourcing fusion reaction products to facilitating research that may lead to breakthroughs in the field of nuclear fusion science.

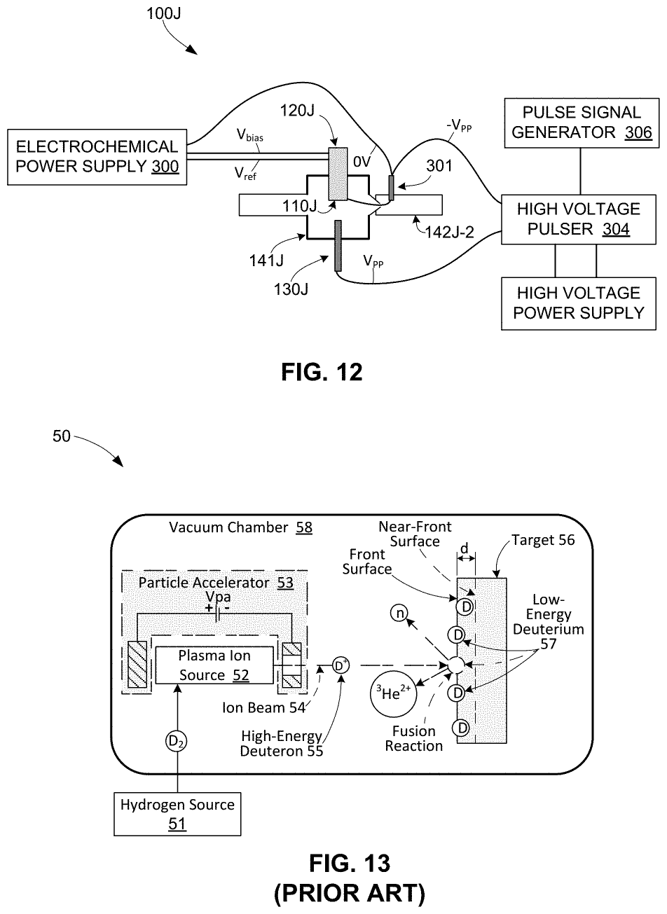

FIGS. 11A, 11B and 12 are simplified schematic diagrams showing a generalized fusion reaction product sourcing apparatus 100J that is enhanced to facilitate nuclear fusion science research according to an exemplary embodiment. FIG. 11A depicts apparatus 100J from a side-view perspective, FIG. 11B depicts apparatus 100J from a top-view perspective, and FIG. 12 shows exemplary electrical sources and connections utilized by apparatus 100J.

Referring to FIG. 11A, similar to the embodiments described above, apparatus 100J includes a target electrode 110J disposed on an electrochemical cell 120J inside a primary vacuum chamber 141J of a vacuum system 140J and operably positioned to receive high-k light element particles from a plasma ion source (particle accelerator) 130J, where each of these structures is configured in accordance with details provided in the embodiments set forth above. Vacuum system 140J includes a gas inflow antechamber 142J-1 and a gas outflow antechamber 142J-2 that are operably coupled to primary vacuum chamber 141J to facilitate the optional introduction of light element gas molecules (e.g., D₂ and/or T₂) and to facilitate the optional isolation of fusion reaction product particles (e.g., He-3 atoms). Inflow antechamber 142J-1 is coupled to an external gas supply 150J by way of a mass flow controller 152J and a valve 154J and is also coupled to a primary chamber vacuum gauge 143J. Outflow antechamber 142J-2 is coupled to primary vacuum chamber 141J by a flow reduction valve 144J and is also coupled to a primary chamber vacuum pump 146J by way of a variable flow valve 148J. Referring to FIG. 12, electrochemical cell 120J receives bias voltage V_{bias} and optional reference voltage V_{ref} from an electrochemical power supply 300, which also provides an associated ground signal (0V) to target electrode 110J by way of a feedthrough 301. A high voltage pulser 304 is controlled by a pulse signal generator 306 to generate plasma signal Vₚ as a high voltage pulse that is utilized by plasma ion source 130J. The structural arrangements and electrical connections depicted in FIGS. 11A, 11B and 12 are not intended to be limiting.

Apparatus 100J is further enhanced to facilitate nuclear fusion science research by way of including one or more reaction product detecting systems that are operably configured to detect fusion reaction products generated by the fusion reactions occurring on target electrode 110J. For example, referring to FIG. 11A, a sampling chamber 310 is operably coupled to outflow antechamber 142J-2 by way of a variable flow valve 312. The vacuum atmosphere inside sampling chamber 310 is controlled by a sampling chamber vacuum pump and associated vacuum gauge 316 to facilitate capturing fusion reaction product particles that may be present in outflow antechamber 142J-2. The particles captured by sampling chamber 310 may be detected and measured using one or more reaction product detecting system 320 (e.g., a residual gas analyzer and/or a mass spectrometer) that is/are operably coupled to sampling chamber 310. Alternatively (or in addition), as indicated in FIG. 11B, one or more reaction product detecting systems (e.g., a neutron detector 330, a charged particle detector 340, or a gamma ray detector (not shown)) may be operably positioned to detect associated reaction products generated inside primary vacuum chamber 141J.

Although the present invention has been described with respect to certain specific embodiments, it will be clear to those skilled in the art that the inventive features of the present invention are applicable to other embodiments as well, all of which are intended to fall within the scope of the present invention.

1. An apparatus for sourcing fusion reaction products comprising:
a target electrode comprising a light-element-absorbing material;
an electrochemical cell including an electrolyte solution containing low-kinetic-energy (low-k) light element particles; and
a particle accelerator configured to direct a plurality of high-kinetic-energy (high-k) light element particles toward the target electrode,
wherein the electrochemical cell is configured to maintain contact between the electrolyte solution and the target electrode such that some of the low-k light element particles are absorbed from the electrolyte solution into the target electrode, and
wherein the particle accelerator is configured to provide each said high-k light element particle with sufficient energy to generate a fusion reaction when said each high-k light element particle operably collides with an associated said low-k light element particle absorbed by the target electrode.

2. The apparatus of claim 1,
wherein the target electrode has a first surface and an opposing second surface,
wherein the electrochemical cell is configured to maintain contact between the electrolyte solution and the second surface of the target electrode, and
wherein the particle accelerator is configured to direct at least a portion of the plurality of high-k light element particles toward the first surface of the target electrode.

3. The apparatus of claim 2, wherein the electrochemical cell further comprises an electrochemical anode disposed in contact with the electrolyte solution and operably coupled to a bias source that is configured to apply an electrochemical bias between the target electrode and the electrochemical anode such that the low-k light element particles are driven from the electrolyte solution to the second surface, whereby the driven low-k light element particles are absorbed through the second surface and diffuse through the light-element-absorbing material to the first surface.

4. The apparatus of claim 3, further comprising a bias control device operably coupled to the bias source and configured to adjust a level of the electrochemical bias applied to the electrochemical anode in response to an externally applied bias control signal, whereby a diffusion rate of the low-k light element particles through the light-element-absorbing material is selectively adjustable by way of variances in a level of the externally applied bias control signal.

5. The apparatus of claim 4, wherein the target electrode comprises a hydrogen absorbing material and both the low-k light element particles and the high-k light element particles comprise hydrogen isotope particles.

6. The apparatus of claim 5, wherein the target electrode comprises palladium and the electrolyte solution comprises hydrogen isotope particles.

7. The apparatus of claim 2, further comprising a vacuum chamber containing a rarefied atmosphere comprising light element gas molecules,
wherein the target electrode is configured such that the first surface is exposed to the rarefied atmosphere,
wherein the particle accelerator comprises a plasma ion source including a counter electrode disposed in the vacuum chamber and configured to produce a plasma discharge between the counter electrode and the target electrode such that the high-k light element particles comprise dissociated light element gas molecules that are accelerated by the plasma discharge toward the first surface of the target electrode.

8. The apparatus of claim 7, further comprising at least one of a hydrogen source and a second electrochemical cell operably configured to supply light element gas molecules into the vacuum chamber.

9. The apparatus of claim 7,
wherein the target electrode comprises a tube-shaped structure including a cylindrical central portion fixedly connected to an upper flange such that a first portion of the tube-shaped structure is disposed inside the vacuum chamber and a second portion of the tube-shaped structure is disposed outside of the vacuum chamber,
where the electrolyte solution is contained within target electrode such that the low-k light element particles diffuse through the cylindrical central portion of the tube-shaped target electrode, and
wherein the plasma ion source includes a cylindrical counter electrode that surrounds the cylindrical central portion of the tube-shaped target electrode.

10. The apparatus of claim 7,
where the electrochemical cell comprises a cylindrical housing containing the electrolyte solution, the electrochemical cell being mounted onto a first flange of the vacuum chamber such that a first end of the cylindrical housing is disposed inside the vacuum chamber,
wherein the target electrode comprises a disk-shaped structure fixedly connected to the first end of the cylindrical housing, and
wherein the plasma ion source includes one or more disk-shaped counter electrodes disposed in parallel with the disk-shaped target electrode.

11. The apparatus of claim 1, wherein the electrochemical cell includes both a counter electrode and a reference electrode disposed in contact with the electrolyte solution.

12. The apparatus of claim 1, wherein the electrochemical cell comprises a recombiner.

13. The apparatus of claim 1, further comprising at least one of a residual gas analyzer, a mass spectrometer, a neutron detector, a charged particle detector and a gamma ray detector operably configured to detect fusion reaction products generated by the fusion reactions.

14. A method for sourcing nuclear fusion products, the method comprising:
electrochemically loading a plurality of low low-kinetic-energy (low-k) light element particles into a target electrode such that some of said low-k element atoms are disposed on a first surface of the target electrode; and
directing a plurality of high-kinetic-energy (high-k) light element particles against the first surface, wherein each said high-k light element particle has sufficient energy to produce a fusion reaction when said each high-k light element particle operably collides with an associated said low-k light element particles disposed on the first surface.

15. The method of claim 14,
wherein the target electrode comprises an electrically conductive light-element-absorbing material having a second surface that opposite to the first surface, and
wherein the electrochemically loading further comprises:
maintaining an electrolyte solution in contact with the second surface of the target electrode, the electrolyte solution including the low-k light element particles, and
applying one of a bias voltage and a bias current to the electrolyte solution such that some of the low-k light element particles disposed in the electrolyte solution are driven to the second surface of the target electrode, and then diffuse through the target electrode to the first surface.

16. The method of claim 14, wherein the electrochemically loading further comprises controlling a diffusion rate of the low-k light element particles through the target electrode to the first surface by way of controllably adjusting a level of said one of the bias voltage and the bias current.

17. The method of claim 14, wherein the electrochemically loading comprises loading hydrogen isotope particles into said target electrode, wherein said target electrode comprises palladium.

18. The method of claim 14, wherein said directing the plurality of high-k light element particles is performed in a rarified environment comprising light element gas molecules, and further comprises utilizing a plasma discharge such that the high-k light element particles comprise dissociated light element gas molecules that are accelerated by the plasma discharge toward the first surface of the target electrode.

19. The method of claim 18, wherein the light element gas molecules are entirely supplied by detachment of the low-k element atoms from the first surface of the target electrode.

20. The method of claim 18, wherein the light element gas molecules are at least partially supplied from one of a hydrogen source and a second electrochemical cell that are operably configured to supply light element gas molecules into the vacuum chamber.

21. The method of claim 15,
wherein said electrochemically loading comprises disposing said electrolyte solution in a tube-shaped target electrode having a cylindrical outer surface, and
wherein said directing comprises disposing a cylindrical counter electrode around the cylindrical outer surface of the tube-shaped target electrode and driving the cylindrical counter electrode such that a plasma cylindrical plasma discharge is generated between the cylindrical counter electrode the cylindrical outer surface of the tube-shaped target electrode.

22. The method of claim 15,
wherein said electrochemically loading comprises disposing said electrolyte solution in a cylindrical housing containing the electrolyte solution such that the electrolyte solution contacts a disk-shaped target electrode secured to a first end of the cylindrical housing, and
wherein said directing comprises disposing a disk-shaped counter electrode adjacent to the disk-shaped target electrode and driving the disk-shaped counter electrode such that a plasma cylindrical plasma discharge is generated between the disk-shaped counter electrode the disk-shaped target electrode.

23. The method of claim 15, wherein said electrochemically loading further comprises utilizing a recombiner to catalyze a recombination of light element gas molecules with oxygen.

24. The method of claim 14, further comprising utilizing at least one of a residual gas analyzer, a mass spectrometer, a neutron detector, a charged particle detector and a gamma ray detector to detect fusion reaction products generated by the fusion reactions.
